(19) United States
(12) Patent Application Publication
(10) Pub. No.: US 2025/0349272 A1
(43) Pub. Date: Nov. 13, 2025

(54) GUITAR WITH NECK SETTING FEATURE

(71) Applicant: TAYLOR-LISTUG, INC. D/B/A TAYLOR GUITARS, El Cajon, CA (US)

(72) Inventor: Andrew Taylor POWERS, Carlsbad, CA (US)

(21) Appl. No.: 18/657,256

(22) Filed: May 7, 2024

(51) Int. Cl. G10D 3/06; G10D 1/08

(52) U.S. Cl. CPC G10D 3/06; G10D 1/08

(57) ABSTRACT

A method and apparatus for adjusting the neck of a guitar having a body, a neck with a fret board formed thereon, wherein an underside of the fret board includes an unsupported section and adjustable means between the body and neck whereby an angle therebetween is adjustable.

### BACKGROUND

### Field

The present invention is directed to a system for adjusting the neck of a stringed instrument, such as a guitar, relative to its body.

### Description of the Related Art

A guitar typically has two main components, a neck and a body. The musician presses the strings of the guitar against frets that are on the neck in order to change pitches of the notes played on the strings. The design of the neck and ease with which the strings can be depressed is therefore an important part of the guitar's performance.

Years of string tension tends to strain or distort the angle at which the neck is joined to the body over time. The wood of the guitar changes shape and the neck angle relative to the guitar body is compromised. Most commonly, this movement in the wood of the guitar raises the height of the strings off the fingerboard, eventually resulting in action so high that the instrument is no longer easily playable. The neck will then need to be removed from the instrument and reset to reestablish the correct geometry between the two main components, bringing the strings closer to the fingerboard again. Presently, a neck reset is a precise repair that is best left to experienced professionals because removing a neck generally involves either unfastening bolts and precision spacers or steaming glue-joints to soften the adhesive.

What is needed is an apparatus and method that simplifies a neck reset by eliminating the need to remove the neck from the guitar body.

### SUMMARY

The present disclosure generally provides an easy, effective and inexpensive way to cure the misalignment of a stringed instrument's body and neck without disassembling the parts of the instrument. In one embodiment, the invention includes a guitar having a body, a neck with a fret board formed thereon, wherein an underside of the fret board includes an unsupported section and adjustable means between the body and neck whereby an angle therebetween is adjustable.

### BRIEF DESCRIPTION OF THE DRAWINGS

FIGS. 1 and 2 are perspective views of an acoustic guitar.

FIG. 3 is an exploded view showing the primary parts of the acoustic guitar of FIGS. 1 and 2.

FIG. 4 is a partial view of a neck portion of the guitar including a heel and fret board and illustrating a pivot formation on the neck, just under the fret board.

FIG. 5 is a perspective view illustrating a connection arrangement between the neck and body of the guitar.

FIG. 6 is a top view of the guitar with a number of section lines referring to other figures to facilitate an understanding of the invention.

FIG. 7 is a section view taken along lines 7-7 of FIG. 6 showing a first adjusted position between the guitar neck and body.

FIG. 8 is a section view taken along lines 8-8 of FIG. 6 showing a second adjusted position between the guitar neck and body.

FIG. 9 is a section view taken along lines 9-9 of FIG. 6 showing a third adjusted position between the guitar neck and body.

FIG. 10 is a perspective view showing a connection arrangement between the neck and body of the guitar and illustrating a pivot formation on the body portion rather than the neck portion.

FIG. 11 is a perspective view showing a connection arrangement between the neck and body of the guitar wherein the neck portion includes an extension and the pivot formation is formed on both sides thereof.

FIG. 12 is a perspective view showing a connection arrangement between the neck and body of the guitar.

FIG. 13 is a cutaway view showing the location and method of the adjustment.

### DETAILED DESCRIPTION

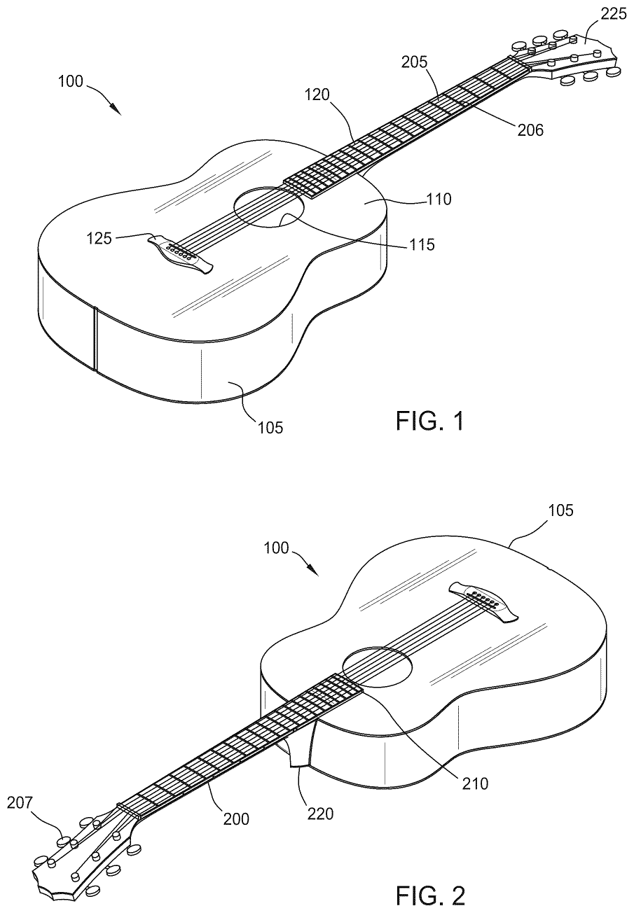

FIGS. 1 and 2 are perspective views of an acoustic guitar 100. The guitar includes a body 105 having a top 110 and a neck 200 attached to the body. The neck includes a fret board 205 having a tail portion 210 extending over a first end of the body adjacent a sound hole 115 formed in the top and a heel portion 220 facilitating connection of the neck 200 to the guitar body 105. A plurality of frets 206 are installed in the fret board 205. The strings 120 of the guitar are attached to the body 105 at a bridge 125 and attached to a distal end of the neck 200 at a headstock 225. Tuners 207 mounted on the headstock permit each string to be tightened or loosened in order to change the pitch of the string.

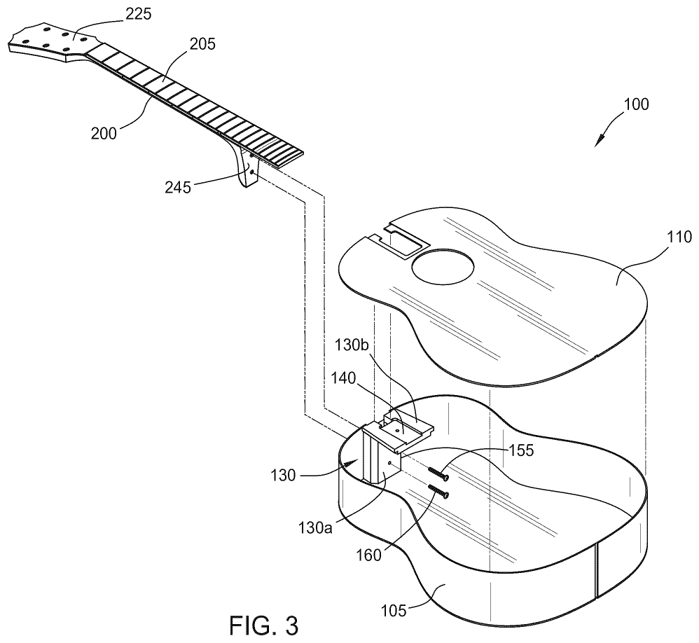

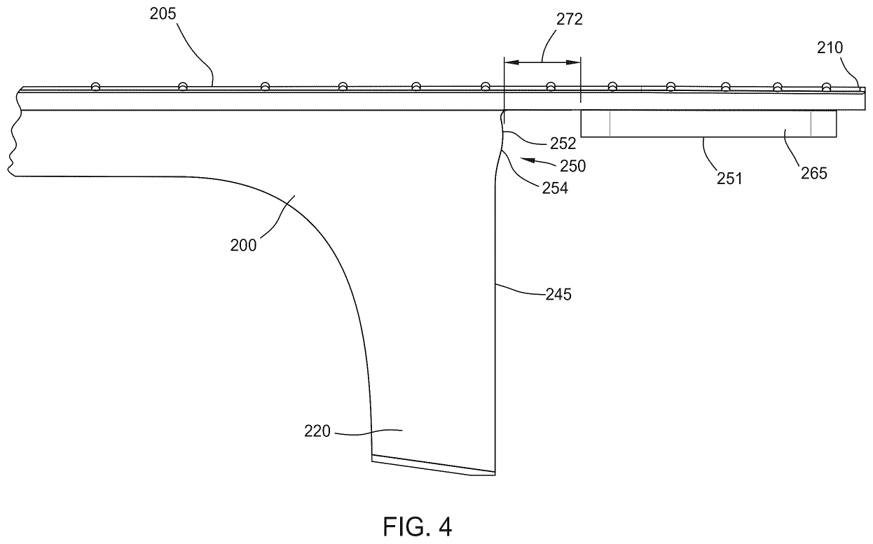

FIG. 3 is an exploded view showing the primary parts of the acoustic guitar 100 of FIGS. 1 and 2. The body 105, in addition to its top 110 includes a structural member 130 having an inverse L-shape. The vertical portion 130a of the member includes a first connection surface 135 formed in a front surface of the body (not visible in FIG. 3) and a second connection surface 140 formed in the horizontal portion 130b of the member and at a right angle to the first connection surface 135. The neck 200, in addition to its fret board 205 and headstock 225, includes a third connection surface 245 for connection to the first surface 135 and a fourth connection surface 251 (see FIG. 4) for connection to the second surface 140 of horizontal portion 130b. Also visible in FIG. 3 are two fasteners, a retention fastener 155 and an adjustment fastener 160 that facilitate a connection between the body 105 and neck 200 portions and adjustment of the neck 200 in relation to the body 105 as will be disclosed herein.

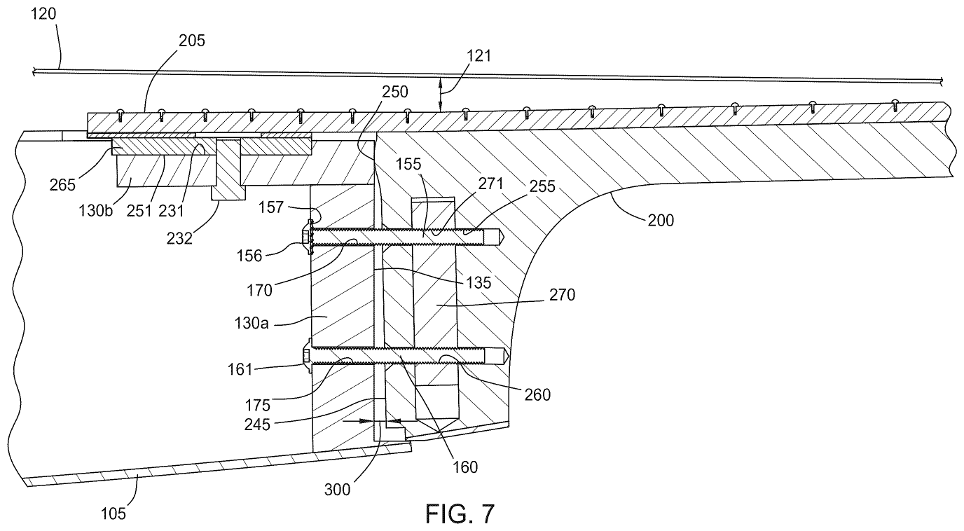

FIG. 4 is a partial view of the neck portion 200 of the guitar 100 including the heel 220 and fret board 205 and a “pivot” 250 formed at an upper end of the third connection surface 245. In the Figure, the fourth connection surface 251 includes a paddle 265 located on an underside of the tail portion 210 of the fret board 205. The purpose of the pivot 250 is to permit the relatively flat surface of the first connection surface 135 of the body 105 to pivot relative to the neck 200, thereby changing an angle between the two portions. In one embodiment, the pivot 250 includes a peak 252 and an angled slope 254 extending from the peak in a direction away from the fret board 205. The height of the peak ensures contact between the neck 200 and body 105 in the area of the pivot 250 while forming an adjustable gap between surface 245, and 135 below the pivot 250 as will be disclosed in relation to FIGS. 7-9. The peak is rounded in order to withstand the physical forces applied to the pivot 250 and the first connection surface 135 by the tensioned strings 120 (not visible in FIG. 4). The relatively shallow angle of the slope 254 facilitates exact positioning of the body 105 relative to the neck 200 during adjustment.

In the embodiment shown, the pivot 250 is an integral part of the neck portion 200 of the guitar and therefore made of the same material. However, it will be understood that the pivot could be a separate piece constructed to fit into a pre-formed aperture in the third connection surface 245. In this manner, the pivot could be made from a variety of different materials. In one embodiment, the pivot 250 is constructed of a harder wood than the neck portion. In another embodiment the pivot is constructed of metal or a composite material. These and equivalent arrangements are within the scope of the invention.

Also shown in FIG. 4 is a “flexible zone” which in the embodiment shown comprises an unsupported section 272 of the fret board. As will be appreciated, the unsupported section 272 permits some flexibility of the fret board 205 as the neck 200 and body 105 portions move relative to one another during adjustment. Because the unsupported section 272 is located between the pivot 250 of the neck 200 and the paddle 265 that will be anchored in the body 105, it is essentially between the two parts of the guitar 100 that will move relative to one another during neck adjustment.

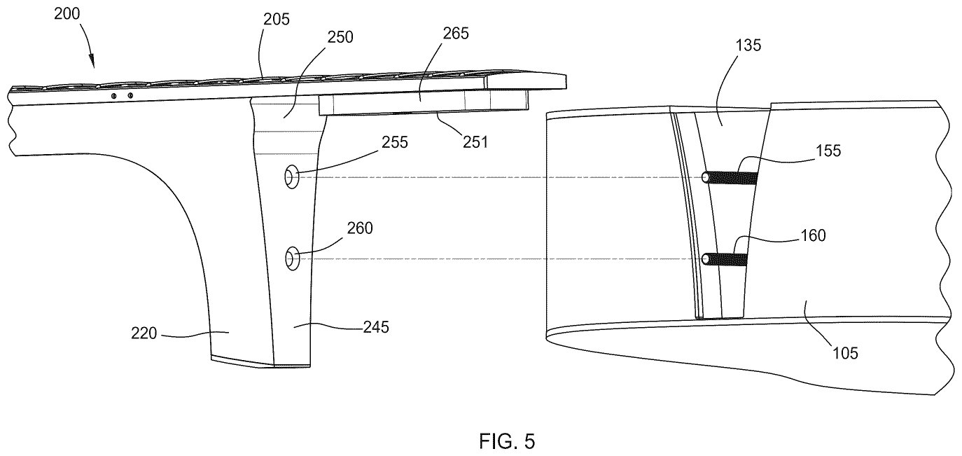

FIG. 5 is a perspective view illustrating a connection arrangement between the neck 200 and body 105 of the guitar 100. Visible is the first connection surface 135 of the body with the retention 155 and adjustment 160 fasteners extending therefrom. The fasteners 155, 160 are constructed and arranged to fit into an upper 255 and lower 260 mating neck apertures formed in the third connection surface 245 of the neck 200. Also visible is the pivot 250 formed at an upper end and extending the width of the third connection surface 245 as well as the paddle 265 formed on an underside of the fretboard 205 for mating with the second connection surface 140 (FIG. 3) of the body. The unsupported section 272 of the fret board described in relation to FIG. 4 is not visible in FIG. 5 but extends between the pivot 250 and the paddle 265.

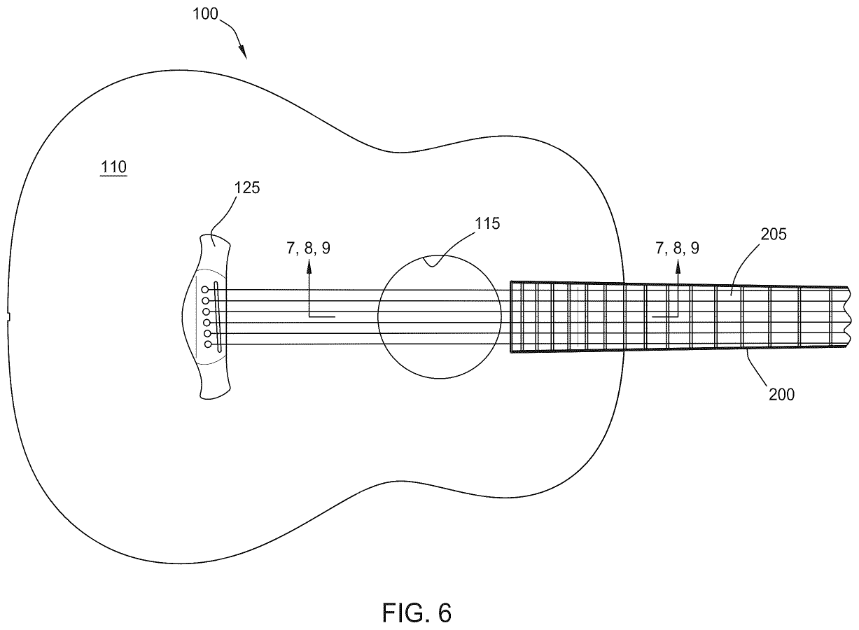

FIG. 6 is a top view of the guitar 100 with a number of section lines and is best appreciated by referring to the referenced Figures.

FIG. 7 is a section view taken along lines 7-7 of FIG. 6 showing a first adjusted position between the guitar neck 200 and body 105. Understanding the Figure requires an explanation of the internal parts of the apparatus. The body portion 105 of the guitar is shown on a left side of the Figure and the neck portion 200 on the right side. The retention 155 and adjustment 160 fasteners extend from an interior of the body through body retention 170 and body adjustment 175 apertures formed in the vertical portion 130a of structural member 130 (the first connection surface) of the body. The fasteners 155, 160 are adjustable with bolt heads 156, 161 within the body accessible via the sound hole 115. From the body, the fasteners extend through a gap 300 formed between the surfaces 135 and 245 and into the neck apertures 255, 260 formed in the third connection surface 245 (see FIG. 3). The second 140 and forth 251 connection surfaces are also visible in the Figure. In the embodiment shown, the underside of paddle 265 (surface 251) serves as the fourth connection surface and joins the body portion 105 of the guitar in a recess formed 231 in the horizontal portion 130b of structural member 130 where it is fixed with a fastener 232.

Each neck aperture 255, 260 extends through a vertically shaped and preferably metallic anchoring member 270 and thereafter into the material of the neck on the other side of the member. While the fasteners 155, 160 are threaded, their only threaded relationship for transferring motion is with corresponding internally formed threads 271 on the interior of the anchoring member. In this manner, the fasteners simply “rotate through” the other parts of the apparatus through which the apertures extend. The bottom end of each aperture is constructed in a manner to prevent the fasteners from “bottoming out”, thereby allowing each fastener to extend and retract a certain amount within its aperture as adjustments to the position of the neck are made. The retention fastener 155 is equipped with a compensating washer 157 intended to compensate for any axial movement that takes place because of the axial movement of the adjustment fastener 160. While the embodiment shown the Figures illustrate a retention fastener, it will be understood that fastener 155 is intended to support the parts and is not necessary for operation of the neck adjustment apparatus. Adjustment is accomplished by the adjustment fastener that in one embodiment is mounted in a relatively low position in relation to pivot 250 to allow a more precise control of gap 300 and resulting precise distance of the strings above the fret board.

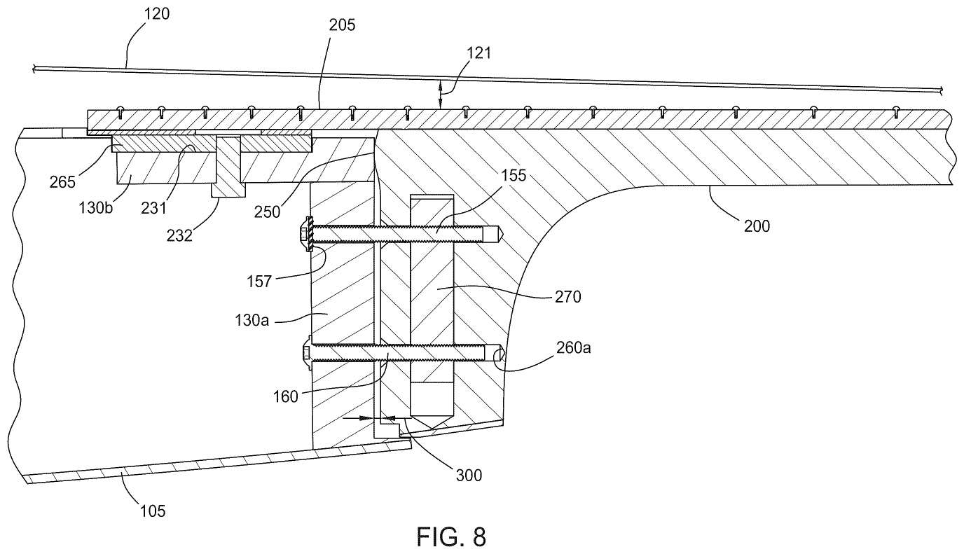

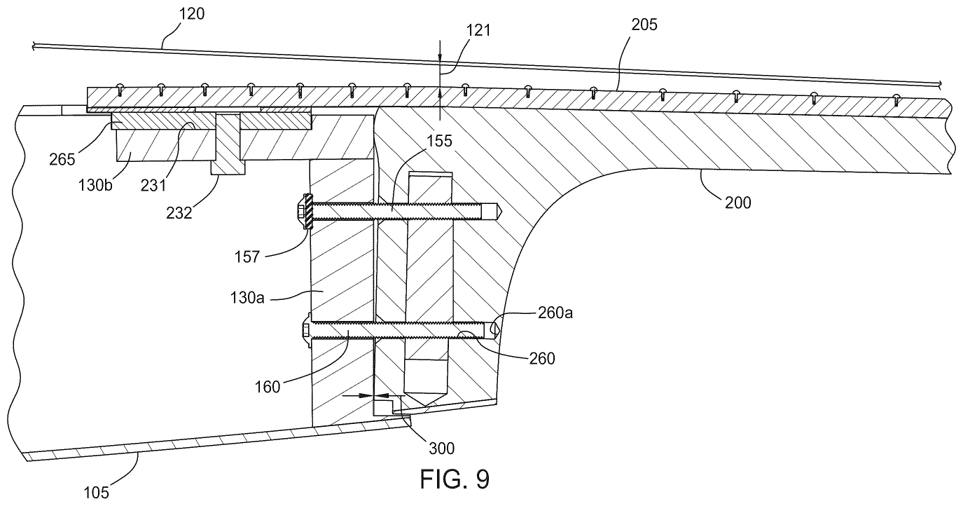

Visible in FIG. 7 is the pivot 250 described with respect to FIG. 4 and located at an upper portion of the third connection surface 245 of the neck 200. The pivot 250 is shown in contact with the relatively flat first connection surface 135 of the body 105. In the illustrated first position, a pivoting motion between the body 105 and neck 200 about the pivot 250 has resulted in the gap 300 between the parts increasing in width from the top of the connection to the bottom thereof. It will be understood that the forces created by string tension along the fret board 205 of the guitar 100 urge the parts to assume the position of FIG. 7 with the gap 300 having an increasing width. The adjustment fastener 155 is responsible for overcoming the string force and creating and maintaining the positions shown in FIGS. 8 and 9. The strings 120 of the guitar are visible above the fret board 205 and like all guitars, gradually increase in height along the length of the guitar from the headstock 225 to the bridge 125 (see FIGS. 1, 2). It will be appreciated by a comparison of FIGS. 7, 8 and 9 that the strings are in a relatively elevated position off the neck and fret board in FIG. 7. The distance 121 of the strings above the fret board is shown in each Figure.

FIG. 8 is a section view taken along lines 8-8 of FIG. 6 showing a second adjusted position between the guitar neck 200 and body 105. The second position is accomplished by turning the adjustment fastener 160 clockwise to transmit motion due to the threaded relationship between the threads of the fastener and the interior of the anchoring member 270, thereby partially closing the gap 300 as the two parts 105, 200 are pulled together about the pivot 250 and against the biasing force of the strings 120. The resulting gap 300 has parallel sides and results in a lower position of the strings 120 in relation to the fret board 205 and neck 200. Additionally, the changed position is illustrated by the position of the adjustment fastener 160 in relation to the bottom 260a of its aperture 260. Also visible is the compensating washer 157 of the retention fastener 155 that has expanded and “compensated” for movement of the fastener head away from the interior wall of the body due to axial movement of the adjustment fastener 160.

FIG. 9 is a section view taken along lines 9-9 of FIG. 6 showing a third adjusted position between the guitar neck 200 and body 105. In this position, the body and neck portions have been further rotated about the pivot 250 to a position wherein the gap 300 is closed at a bottom end and the strings 120 are even lower in relation to the fret board 205. The compensating washer 156 has expanded further and the end of the adjustment fastener 160 is closer to the bottom 260a of its corresponding aperture 260.

Also visible in FIGS. 7-9 is the fretboard extension 220 and paddle 265 fastened to surface 140 in portion 130b. The flexibility of unsupported section 272 (FIG. 4), allows this portion remains stationary throughout the adjustment range illustrated in FIGS. 7-9.

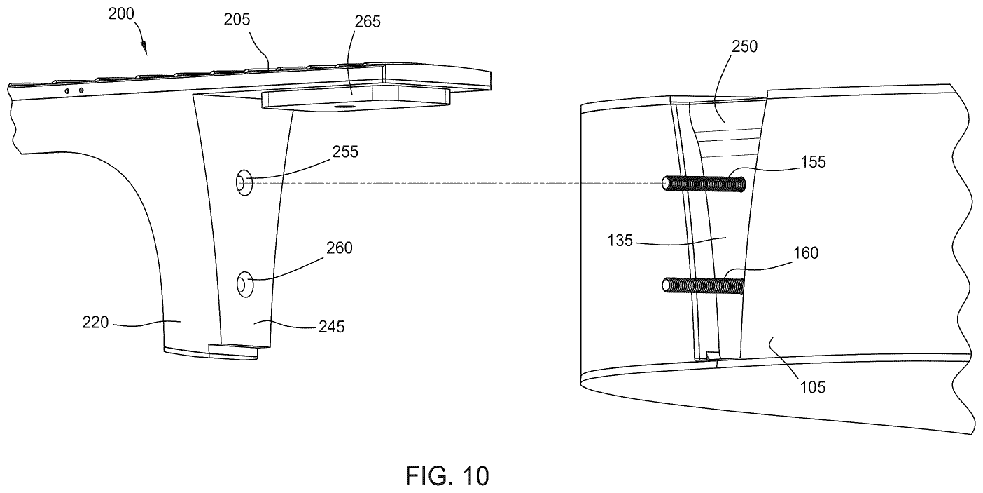

FIG. 10 is a perspective view showing a connection arrangement between the neck 200 and body 105 of the guitar 100 and wherein the pivot 250 is formed on the body portion 105 rather than the neck portion 200. Rather than the pivot 250 operating against an essentially flat surface of the body, in FIG. 10 the pivot 250 acts against a relatively flat surface of the third connection surface 245 of the neck. In other aspects, operation of the neck adjustment mechanism is the same as illustrated in FIGS. 7-9.

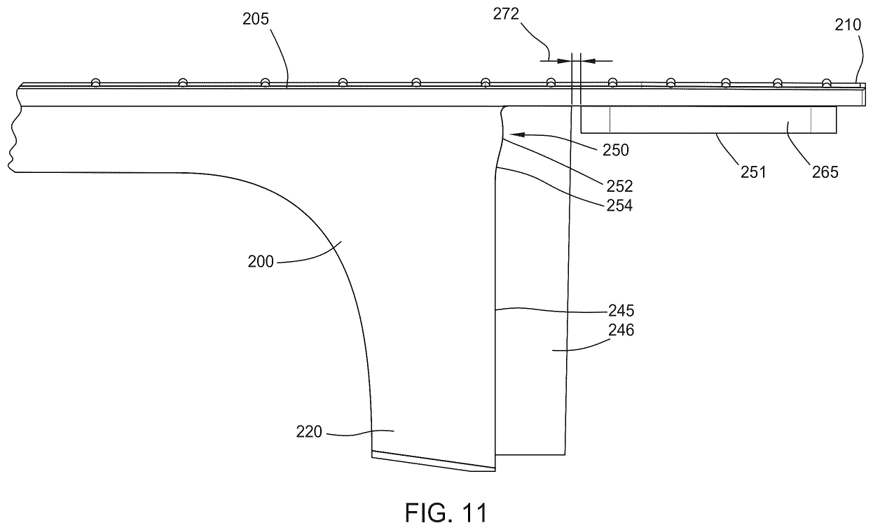

FIG. 11 is a partial view of a neck portion of a guitar 100 including a heel 220 and fret board 205 and wherein the third connection surface 245 of the neck portion includes an extension 246 and the pivot 250 is formed on either side of the extension 246. Due to the extension 246 and its position relative to corresponding parts of the body, the unsupported section 272 in this embodiment is considerably smaller in width than the unsupported section shown in the embodiment of FIG. 4, but permits flexibility nonetheless.

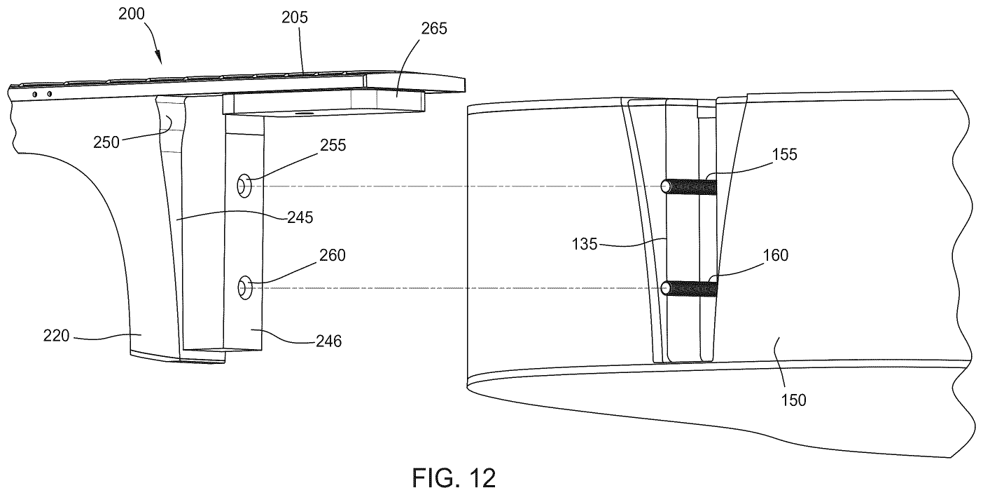

FIG. 12 is a perspective view showing a connection arrangement between the neck and body of the guitar wherein the third connection surface 245 of the neck portion 200 includes the extension 246. The extension provides additional stability for the connection between the parts and the first connection surface 135 of the body 105 includes a deeper “pocket” in order to receive the extension.

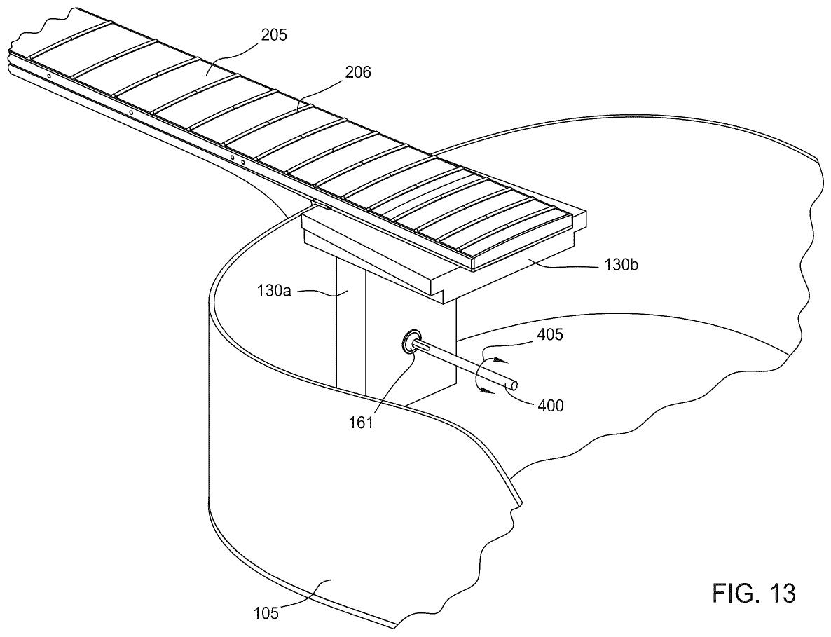

FIG. 13 is a cutaway view showing the location and method of neck adjustment. As previously described, bolt head 161 of adjustment fastener 160 is accessible in the face of vertical portion 130a of structural member 130. As illustrated, a tool 400 can be used to rotate the fastener in either a clockwise or counterclockwise direction, depending on the desired string height. In one embodiment, the bolt head is accessible from the sound hole 115 (not shown) in the top 110 (not shown) of the guitar.

The disclosure presents a simple and easy way to adjust the neck of a guitar relative to the body without disassembling the parts. As disclosed, the invention preferably includes a pivot formed on either the neck or the body portion in a manner whereby the portions can rotate about each other to change the angle of the neck relative to the body. In one embodiment, the pivot includes a peak and a slope having an angle permitting any number of precise positions between the parts. In one embodiment, angular movement between the neck and body is accomplished by an adjustment fastener—a threaded member that can move the parts about the pivot resulting in a change of string height over the fret board of the neck. In one embodiment, an adjustment fastener reachable through the body sound hole. In one embodiment, in addition to the adjustment fastener the apparatus includes a retention fastener-a threaded member responsible for holding the parts together. In each case, adjustment is facilitated by an unsupported section of the fret board near the pivot point.

In practice, the angle of the neck of a guitar is adjusted in the following manner: the neck and body are factory set typically setting the adjustment apparatus to a neutral setting like the one shown in FIG. 8. If and when the player wants to adjust the string height, either due to environmental effects on the instrument or simply a desire to play the guitar with a different string height, the adjustment fastener is rotated either clockwise or counterclockwise, typically with a tool inserted into the body sound hole for mating with the head of the adjustment fastener. In this manner, motion is transmitted either urging the parts together or apart about the pivot. In one embodiment, clockwise rotation of the fastener results in a lower string height while counterclockwise rotation raises the strings.

It is contemplated that any one or more elements or features of any one disclosed embodiment may be beneficially incorporated in any one or more other non-mutually exclusive embodiments. While the foregoing is directed to embodiments of the present disclosure, other and further embodiments of the disclosure may be devised without departing from the basic scope thereof, and the scope thereof is determined by the claims that follow.

1. A guitar with a neck adjustment feature, comprising:
a body portion having a first and second connection surfaces, the surfaces generally at right angles relative to one another;
a neck portion connectable to the body, the neck portion having a third and fourth connection surfaces for alignment with the first and second surfaces;
wherein the first connection surface lies in a recess formed in a front surface of the body and aligns with the third connection surface of the neck portion to create a connection between the body and neck;
a pivot formed at an upper end of the third connection surface, the pivot constructed and arranged to contact the first connection surface forming a pivot point between the neck and body in a manner wherein the body and neck are rotatable about the pivot point to form a predetermined angle therebetween;
a fret board formed on and supported by an upper surface of the neck and having a tail portion extending over and supported by the body; and wherein an underside of the fret board includes an unsupported section near the pivot point.

2. The guitar of claim 1, wherein the pivot includes a peak and a slope extending from the peak in a direction away from the fret board.

3. The guitar of claim 2, wherein the adjustable angle includes a first position wherein a gap formed between the body and neck increases in width between an upper and lower end of the gap, a mid position wherein the gap maintains a substantially uniform width between the upper and lower end and a third position wherein the gap decreases in width between the upper and lower ends.

4. The guitar of claim 2, wherein the adjustable angle includes a first position wherein the strings are in a higher position over an upper surface of the fret board, a mid position wherein the strings are in a lower position and a third position wherein the strings are in a lowest position due to the movement of the neck and body about the pivot point.

5. The guitar of claim 4, wherein rotation about the pivot point is accomplished with an internal adjustment member constructed and arrange to move the body and neck to any of a plurality of positions about the pivot point.

6. The guitar of claim 5, wherein the adjustment member is a threaded fastener accessible from an interior of the body via a sound hole formed in the top, the adjustment fastener in a threaded relationship to the neck portion.

7. The guitar of claim 6, further including a retention fastener, the retention fastener in a threaded relationship to the neck portion.

8. The guitar of claim 7, wherein the adjustment and retention fasteners are threaded into an anchoring member, the member disposed in the neck behind the third connection surface.

9. The guitar of claim 2, wherein the pivot extends across the width of the third connection member.

10. The guitar of claim 2, wherein the third connection surface includes an extension extending therefrom, the pivot formed on either side thereof.

11. A guitar with a neck adjustment feature, comprising:
a body portion having a first and second connection surfaces, the surfaces generally at right angles relative to one another;
a neck portion connectable to the body, the neck portion having a third and fourth connection surfaces for alignment with the first and second surfaces;
wherein the first connection surface lies in a recess formed in a front surface of the body and aligns with the third connection surface of the neck portion to create a connection between the body and neck;
a pivot formed at an upper end of the first connection surface, the pivot constructed and arranged to contact the third connection surface forming a pivot point between the neck and body in a manner wherein the body and neck are rotatable about the pivot point to form a predetermined angle therebetween;
a fret board formed on and supported by an upper surface of the neck and having a tail portion extending over and supported by the body; and
wherein an underside of the fret board includes an unsupported section over the pivot point.

12. A method of adjusting the neck of a guitar, comprising:
providing a body portion having a first connection surface
providing a neck portion having a second connection surface for connection to the first connection surface of the body, the second connection surface including a pivot formed thereon in a manner wherein the pivot acts on the first surface of the body to create an angle between the body and neck;
providing an adjustment fastener extending from the body to the neck, the fastener constructed and arranged to enlarge or reduce the angle between the body and the neck;
rotating the fastener to change the angle, thereby changing the height of strings above a fret board.

13. The method of claim 12, wherein the fastener is located in the body of the guitar and is accessible via a sound hole formed in the top of the body.

14. A guitar with a neck adjustment feature, comprising:
a body;
a neck with a fret board formed thereon, wherein an underside of the fret board includes an unsupported section; and
adjustable means between the body and neck whereby an angle therebetween is adjustable.

15. The guitar of claim 14, wherein the adjustable means includes a threaded member located within the body and accessible via a sound hole in the top of the body.

16. The guitar of claim 15, wherein the angle is created due to a pivot permitting separation between the body and neck at a predetermined location there between.

17. The guitar of claim 16, wherein rotation of the threaded member changes the angle.

18. The guitar of claim 17, wherein rotation of the threaded member in a clockwise direction causes a reduction in height of guitar strings above a fret board.
